(19) United States
(12) Patent Application Publication
(10) Pub. No.: US 2024/0332719 A1
(43) Pub. Date: Oct. 3, 2024

(54) POWER TOOL BATTERY WITH VENTS

(71) Applicant: Snap-on Incorporated, Kenosha, WI (US)

(72) Inventors: Ottoleo Kuter-Arnebeck, Kenosha, WI (US); Nicholas A. Gabbey, Kenosha, WI (US)

(73) Assignee: Snap-on Incorporated, Kenosha, WI (US)

(21) Appl. No.: 18/127,954

(22) Filed: Mar. 29, 2023

(51) Int. Cl. H01M 50/325; B25F 5/02; H01M 50/213; H01M 50/247

(52) U.S. Cl. CPC H01M 50/325; B25F 5/02; H01M 50/213; H01M 50/247; H01M 2200/20; H01M 2220/30

(57) ABSTRACT

A battery pack that includes one or more vents on the battery pack housing. The vents to direct battery gasses out in the housing from the front of the battery pack housing. The battery pack housing may also be hermetically sealed to the external environment and include a pressure disc or check valve behind the vent to prevent incursion of external contaminated air or fluids while still allowing internal gasses or liquids to escape from the battery pack case.

### TECHNICAL FIELD OF THE INVENTION

The present invention relates generally to battery pack for a power tool, and more specifically to a battery pack having vents adapted to allow battery gases to escape the battery pack.

### BACKGROUND OF THE INVENTION

A typical battery pack, such as those used with power tools, is constructed with a housing having multiple internal battery cells. During use and/or recharging, the battery cells may typically create by-product gasses. However, conventional battery packs are typically either ventless, which does not allow the battery gases to escape the battery housing, which can create dangerous and/or damaging battery gas pressure increases, or are vented to the internal of the tool body, which then vents battery gases directly into the power tool. Also, some conventional battery packs may include a pressure release valve, which is activated when the internal gas pressures reach a certain amount. But, again, in such situations, unless the pressure release valve is activated, the gases cannot escape the battery pack and pressure builds

Additionally, when the battery pack is compromised, the internal pressurized contents of the battery cell may violently escape because the damaged exterior surface of the battery cell can no longer hold in the internal contents, especially in ventless battery packs. Similarly, if the battery pack is overheated or the cells are overcharged or due to other defects, the gas pressures can increase and overcome the retention strength of the battery cell walls, or the pressure relief valve disposed in the cell cap and escape rendering the cells safe as the fuel for a chemical/electrical fire is now dispersed.

Further, in packs that may contain pressurized battery cells, the release of pressurized gases inside the battery pack housing can react unpredictably and create flying debris or direct pressurized gases towards the user.

### SUMMARY OF THE INVENTION

The present invention relates broadly to a battery pack used for powering tools, such as drills, grinders, and the like, that includes one or more vents on the battery pack housing. The battery pack may feature one or more vents to direct battery gasses out of the front of the battery pack housing. The battery pack housing may also be hermetically sealed to the external environment and include a pressure disc or check valve behind the vent to prevent incursion of contaminated air or fluids and to allow battery gasses to escape from the battery pack case.

According to an embodiment, a battery pack for a tool having a tool body and a motor is disclosed. The battery pack may include a housing including a vent. The vent may be adapted to direct gasses away from a user. A battery cell may be disposed in the housing. A connection interface may be operatively coupled to the battery cell and the motor.

According to another embodiment, a power tool may include a tool body having a head and a base. A motor may be disposed in the tool body. A battery pack may be coupled to the base of the tool body. The battery pack may include, a housing having a vent, one or more battery cells disposed in the housing, and a connection interface electrically coupling the one or more cells to the motor.

### BRIEF DESCRIPTION OF THE DRAWINGS

For purposes of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a side view of an exemplar tool and a battery pack incorporating an embodiment of the present invention.

FIG. 2A is front view of an exemplar battery pack, according to an embodiment of the present invention.

FIG. 2B is a side view of an exemplar battery pack, according to an embodiment of the present invention.

### DETAILED DESCRIPTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention but is instead used to discuss exemplary embodiments of the invention for explanatory purposes only.

The present invention relates broadly to a battery pack for a power tool, such as a drill, grinder, or the like. The battery pack may include one or more battery cells. The battery pack housing may include one or more vents that are adapted to improve the safety of the user by allowing pressurized gases, typically created by the battery cells, to escape the housing in a preferred location and direction. When overheated or punctured, the pressurized gases of the housing may release quickly, either through a vented and controlled exit path. By preventing the unknown exit path of the pressure, danger to a user is reduced.

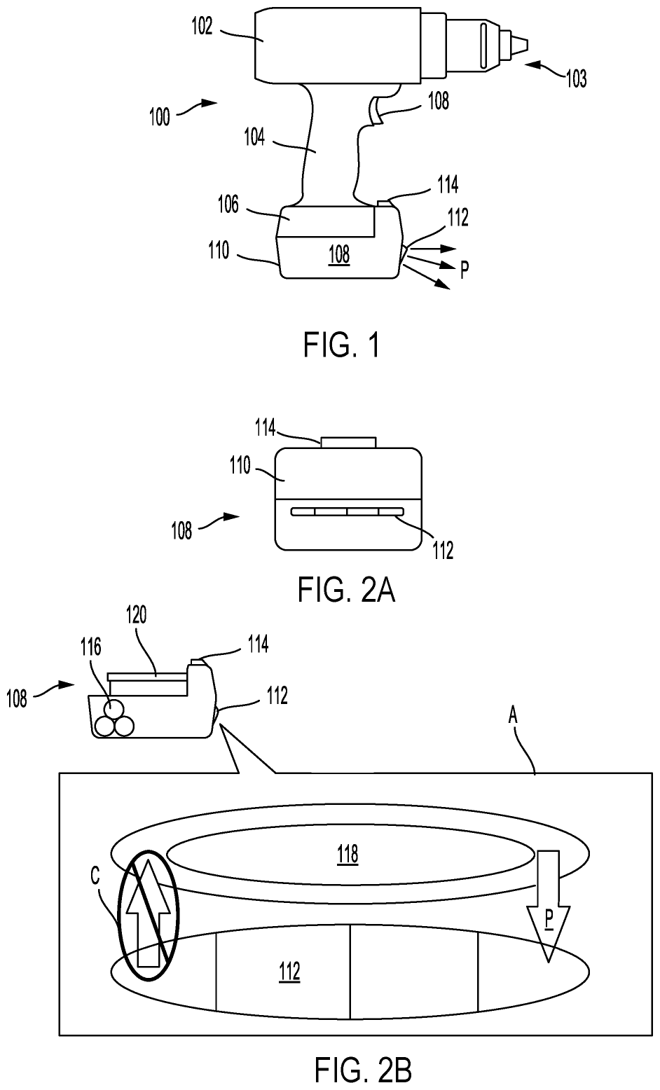

Referring generally to FIGS. 1-2B, an exemplar power tool 100 and battery pack 110 are shown, according to an embodiment of the present invention. The power tool 100 be a drill, for example, having tool body 102, handle 104, trigger 108, tool head 103, and base 106. As is known in the art, during operation, actuation of the trigger 108 may cause electrical current to be drawn from the battery pack 110 to drive the operation of the tool, for example, a motor adapted to drive rotation of the tool head 103, to act on a workpiece. While the power tool 100 is shown as a drill, one skilled in the art will recognize that the scope of the invention is not limited to merely a drill or power tool, but may include other battery powered devices, such a, for example, power ratchets, power impact wrenches, torque wrenches, grinder, or other battery-powered devices.

A battery pack 108 may be operatively coupled to the tool 100. According to an embodiment, the battery pack 108 may include a housing 110, a release 114, a connection interface 120, and one or more battery cells 116 disposed in the housing. The battery cells 116 may include one or more of lithium-ion, nickel-cadmium, nickel-metal hydride, or the like. The release 114 may include an actuating locking feature, such as a button, lever, latch mechanism, or the like, that is adapted to selectively secure the battery pack 108 to the base 106 of the tool 100. Actuation of the release 114 may allow a user to remove the battery pack 108 easily and safely to recharge or replace with another battery pack 108. The connection interface 120 may be adapted to supply electrical current to the operative components of the tool 100, including, but not limited to, a motor, a display, a light, or other powered function, as is known in the art.

According to an embodiment, the safety of battery pack 108 may be improved by including or defining one or more vents 112 in the housing 110, where the vents provide a path from the inside of housing 110 to outside of the housing 110. In an embodiment, and as shown in FIG. 1, the battery pack 110 may include or define one or more vents 112 to direct any internal gasses P out from the front of the housing 110 away from the user's hand and face.

According to an embodiment, the battery cells 116 may be pressurized. In such cells 116, should the cells rupture, melt, or otherwise become compromised, the stored pressurized contents, the gases or liquids in the pressurized battery cells 116, may require an escape path out of the housing 116. The incorporation of a vent 112 into the housing 110 to direct escaping gas, liquid, or both, away from a user and internal components of the tool, thereby providing a safety feature for the user. The vent 112 may create and allow a safe fluid (air and/or liquid) path from inside the housing 110 and away from the user. The vent may further keep the internal pressure inside the housing 110 from building internally too high.

In another embodiment, the battery pack housing 110 may be hermetically sealed from the environment to protect the interior of the housing 110 from outside contaminants that may compromise operation and/or integrity of the battery pack 108. As shown in a partial blow-up A in FIG. 2B, the battery pack 110 may further include a one-way valve 118, such as a pressure disc, check valve, pressure relief valve, or other pressure sensitive gateway, disposed behind the vent 112. The valve 118 may be adapted to prevent incursion into the housing 110 of atmospheric or fluidic contaminants (FIG. 2B, C) from outside of the housing 110, yet allow potential battery gasses, P, to release from the housing 110.

As used herein, the term “coupled” and its functional equivalents are not intended to necessarily be limited to direct, mechanical coupling of two or more components. Instead, the term “coupled”, and its functional equivalents are intended to mean any direct or indirect mechanical, electrical, or chemical connection between two or more objects, features, work pieces, and/or environmental matter. “Coupled” is also intended to mean, in some examples, one object being integral with another object. As used herein, the term “a” or “one” may include one or more items unless specifically stated otherwise.

As used herein terms denoting direction, order, or orientation such as “first,” “second,” “horizontal,” “vertical,” “lateral,” “top,” “bottom,” “left,” “right,” “over,” “under,” “above,” “below,” “front,” back,” or the like, are non-limiting and used herein for ease of explanation. One of skill in the art will recognize the use of these terms as merely descriptive examples that do not limit the placement, orientation, or disposition of the elements described using such terms.

The matter set forth in the foregoing description and accompanying drawings is offered by way of illustration only and not as a limitation. While particular embodiments have been shown and described, it will be apparent to those skilled in the art that changes, and modifications may be made without departing from the broader aspects of the inventors' contribution. The actual scope of the protection sought is intended to be defined in the following claims when viewed in their proper perspective based on the prior art.

What is claimed is:

1. A battery pack comprising:
a housing including a vent that is adapted to release fluid from an interior of the housing;
a battery cell disposed in the housing; and
a connection interface operatively coupled to the battery cell.

2. The battery pack of claim 1, wherein the housing includes a first side facing away from a user, wherein the vent is defined in the first side.

3. The battery pack of claim 1, wherein the vent is substantially sealed from an external environment.

4. The battery pack of claim 3, wherein the vent is substantially hermitically sealed.

5. The battery pack of claim 3, further comprising a valve disposed in the housing, wherein the valve in fluid communication with the interior of the housing and the external environment through the vent.

6. The battery pack of claim 5, wherein the valve includes a pressure disc.

7. The battery pack of claim 5, wherein the valve includes a check valve.

8. The battery pack of claim 1, wherein the battery cell is a lithium-ion cell.

9. The battery pack of claim 1, wherein the battery cell is a nickel-cadmium cell.

10. The battery pack of claim 1, wherein the battery cell is a nickel-metal hydride cell.

11. The battery pack of claim 1, wherein the connection interface is releasable.

12. The battery pack of claim 1, wherein the housing includes a locking release.

13. A power tool comprising:
a tool body having a head and a base;
a motor disposed in the tool body; and
a battery pack coupled to the base of the tool body, the battery pack including:
a housing including a vent;
a battery cell disposed in the housing; and
a connection interface electrically coupling the battery cell.

14. The power tool of claim 13, wherein the vent is disposed in a front side of the housing, and wherein the front side faces away from a user.

15. The power tool of claim 13, wherein the vent is substantially hermetically sealed.

16. The power tool of claim 15, wherein the vent includes a valve in fluid communication with an interior of the housing and an external environment.

17. The power tool of claim 16, wherein the valve includes a pressure disc.

18. The power tool of claim 16, wherein the valve includes a check valve.

19. The power tool of claim 13, wherein the battery cell is one of a lithium-ion cell, a nickel-cadmium cell, or a nickel-metal hydride cell.

20. The power tool of claim 13, wherein the connection interface is releasable.
